(19) United States
(12) Patent Application Publication
(10) Pub. No.: US 2016/0257069 A1
(43) Pub. Date: Sep. 8, 2016

(54) SHAPING APPARATUS

(71) Applicant: FUJI XEROX CO., LTD., Tokyo (JP)

(72) Inventor: Shin YASUDA, Kanagawa (JP)

(21) Appl. No.: 14/799,310

(22) Filed: Jul. 14, 2015

(30) Foreign Application Priority Data
Mar. 5, 2015 (JP) 2015-043879

(51) Int. Cl. B29C 67/00

(52) U.S. Cl. CPC B29C 67/0059; B29C 67/0066; B29C 67/007; B29C 67/0085; B33Y 30/00

(57) ABSTRACT

Provided is a shaping apparatus including an ejection section that ejects a liquid droplet containing a curable resin and that overlaps layers formed of the liquid droplets to form a three-dimensional object, and a forming section that forms, on the layer, a suppressing portion that suppresses a movement of the liquid droplet ejected by the ejection section on the layer.

### CROSS-REFERENCE TO RELATED APPLICATIONS

This application is based on and claims priority under 35 USC 119 from Japanese Patent Application No. 2015-043879 filed Mar. 5, 2015.

### BACKGROUND

### Technical Field

The present invention relates to a shaping apparatus.

### SUMMARY

According to an aspect of the invention, there is provided a shaping apparatus including:

an ejection section that ejects a liquid droplet containing a curable resin and that overlaps layers formed of the liquid droplets to form a three-dimensional object; and

a forming section that forms, on the layer, a suppressing portion that suppresses a movement of the liquid droplet ejected by the ejection section on the layer.

### BRIEF DESCRIPTION OF THE DRAWINGS

Exemplary embodiments of the present invention will be described in detail based on the following figures, wherein:

FIG. 1 is a diagram (front view) schematically showing a state in which a shaping apparatus according to a first exemplary embodiment shapes a three-dimensional object;

FIG. 2 is a diagram (top view) schematically showing a part of the shaping apparatus in a state in which the shaping apparatus according to the first exemplary embodiment shapes the three-dimensional object;

FIG. 3 is a perspective view showing a part of a contact roll constituting the shaping apparatus according to the first exemplary embodiment;

FIG. 4 is a diagram (front view) schematically showing a state in which convex portions are formed on a layer in a process in which the shaping apparatus according to the first exemplary embodiment shapes the three-dimensional object;

FIG. 5 is a diagram schematically showing the layer on which the convex portions are formed in the process in which the shaping apparatus according to the first exemplary embodiment shapes the three-dimensional object;

FIG. 6 is a diagram schematically showing a state in which a liquid droplet is ejected on the layer on which the convex portions are formed in the process in which the shaping apparatus according to the first exemplary embodiment shapes the three-dimensional object;

FIG. 7 is a diagram schematically showing a state in which the plural adjacent liquid droplets ejected on the layer, on which the convex portions are formed, are integrated with each other in the process in which the shaping apparatus according to the first exemplary embodiment shapes the three-dimensional object;

FIG. 8 is a diagram schematically showing a state in which the liquid droplets integrated with each other on the layer are irradiated with light and are cured in the process in which the shaping apparatus according to the first exemplary embodiment shapes the three-dimensional object;

FIGS. 9A to 9C are diagrams showing a process in which a shaping apparatus according to a comparative embodiment (first comparative embodiment) shapes the three-dimensional object; FIG. 9A shows a state in which one of two liquid droplets lands on a layer and the other liquid droplet has yet to land on the layer, FIG. 9B schematically shows a state in which the two liquid droplets landed on the layer are integrated with each other, and FIG. 9C schematically shows a state in which the integrated two liquid droplets move and stop moving;

FIG. 10A is a diagram schematically showing a contact angle formed in a state (equilibrium state) in which a liquid droplet stops moving on a layer and FIG. 10B is a diagram schematically showing a relationship between contact angles formed in a state of the liquid droplet that moves on the layer;

FIGS. 11A to 11C are diagrams showing a process in which the shaping apparatus according to the first exemplary embodiment shapes the three-dimensional object; FIG. 11A schematically shows a state in which one of two liquid droplets lands on the layer and the other liquid droplet has yet landed on the layer, FIG. 11B schematically shows a state in which the two liquid droplets landed on the layer are integrated with each other, and FIG. 11C schematically shows a state in which the integrated two liquid droplets move and stop moving;

FIGS. 12A and 12B are diagrams showing the behavior of two liquid droplets landed on the layer on which the convex portion is formed in the process in which the shaping apparatus according to the first exemplary embodiment shapes the three-dimensional object; FIG. 12A schematically shows a state immediately after the two liquid droplets land on the layer and FIG. 12B schematically shows a state in which the two liquid droplets landed on the layer are integrated with each other and stop moving;

FIGS. 13A and 13B are diagrams showing the behavior of two liquid droplets landed on the layer on which the convex portion is formed in the process in which the shaping apparatus according to the first exemplary embodiment shapes the three-dimensional object; FIG. 13A schematically shows a state immediately after the two liquid droplets land on the layer and FIG. 13B schematically shows a state in which one of the two liquid droplets landed on the layer is integrated with a portion of the other liquid droplet and stop moving;

FIG. 14 is a perspective view showing a part of a contact roll constituting a shaping apparatus according to a modification example of the first exemplary embodiment;

FIG. 15 is a diagram (front view) schematically showing a state in which powder adheres on a layer in a process in which a shaping apparatus according to a second exemplary embodiment shapes a three-dimensional object;

FIG. 16 is a diagram schematically showing the layer on which the powder adheres in the process in which the shaping apparatus according to the second exemplary embodiment shapes the three-dimensional object;

FIG. 17 is a diagram schematically showing a state in which a liquid droplet is ejected on the layer on which the powder adheres in the process in which the shaping apparatus according to the second exemplary embodiment shapes the three-dimensional object;

FIGS. 18A and 18B are diagrams schematically showing a state in which the plural adjacent liquid droplets ejected on the layer, on which the powder adheres, are integrated with each other in the process in which the shaping apparatus according to the second exemplary embodiment shapes the three-dimensional object; and

FIG. 19 is diagram schematically showing a state in which the liquid droplets integrated with each other on the layer are irradiated with light and are cured in the process in which the shaping apparatus according to the second exemplary embodiment shapes the three-dimensional object.

### DETAILED DESCRIPTION

### Outline

Hereinafter, exemplary embodiments will be described. First, the first exemplary embodiment and a modification example thereof are described and then, the second exemplary embodiment is described. In the following description, a ±Z direction in the drawings indicates an apparatus height direction (a Z direction and a −Z direction indicate an upward side and a downward side, respectively), a ±X direction indicates an apparatus width direction (an X direction and a −X direction indicate one end side and the other end side, respectively), and a direction (a ±Y direction) intersecting with a ±Z direction and a ±X direction indicates an apparatus depth direction (a Y direction and a −Y direction indicate a backward direction and a frontward direction, respectively).

### First Exemplary Embodiment

Hereinafter, a shaping apparatus 10 according to the first exemplary embodiment will be described with reference to the drawings. First, a configuration of the shaping apparatus 10 according to the present exemplary embodiment is described. Then, a method of shaping a three-dimensional object VM by the shaping apparatus 10 according to the present exemplary embodiment will be described. Subsequently, effects of the present exemplary embodiment will be described.

### Configuration of Shaping Apparatus of First Exemplary Embodiment

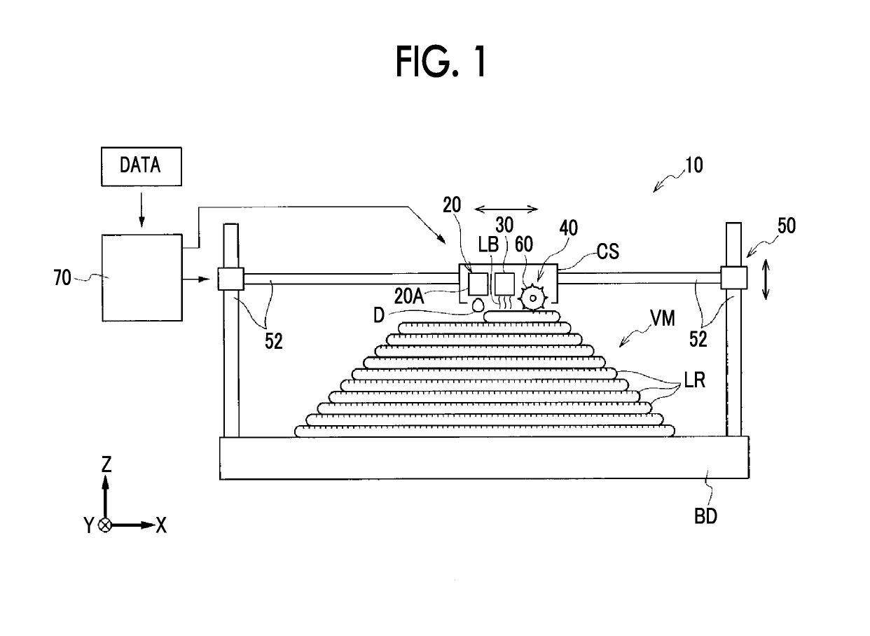

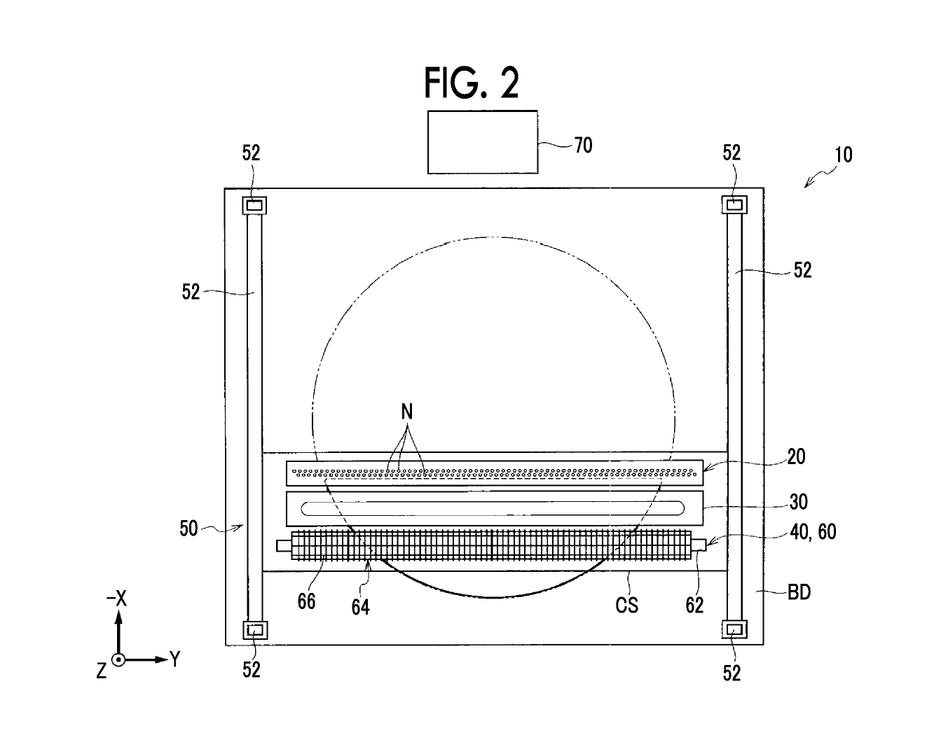

The shaping apparatus 10 according to the present exemplary embodiment has a function of ejecting a liquid droplet D and of overlapping layers LR formed of the liquid droplets D and shaping the three-dimensional object VM (refer to FIG. 1 and FIG. 2).

As shown in FIG. 1 and FIG. 2, the shaping apparatus 10 is configured to include a base plate BD, an ejection unit 20, an irradiation unit 30, a contact unit 40, a moving unit 50, and a control unit 70.

### Base Plate

As shown in FIG. 1 and FIG. 2, the base plate BD is a plate having a top surface in the apparatus width direction and in the apparatus depth direction. The three-dimensional object VM is formed on the top surface of the base plate BD.

### Ejection Unit

The ejection unit 20 has a function of ejecting the liquid droplet D and of overlapping the layers LR formed of the liquid droplets D to form the three-dimensional object VM. Here, the ejection unit 20 represents an example of an ejection section.

As shown in FIG. 1 and FIG. 2, the ejection unit 20 is long and is disposed in a state in which a longitudinal direction thereof is parallel to the apparatus depth direction. The ejection unit 20 has an underside 20A facing the base plate BD. Plural nozzles N are arranged on the underside 20A from the one end side to the other end side in the longitudinal direction in a series of zigzags. The ejection unit 20 is configured to travel from one end side to the other end side in the apparatus width direction in response to data received from an external device (not shown) and to eject the liquid droplet D from plural nozzles N. Here, the data includes data of the three-dimensional object VM. The liquid droplet D discharged from the ejection unit 20 is a transparent liquid droplet containing a light curable resin. In addition, the liquid droplet D is transparent even after being irradiated with light LB by the irradiation unit 30 to be described below. Here, the light curable resin represents an example of a curable resin. The light curable resin according to the present exemplary embodiment has, for example, a property of absorbing ultraviolet light and being cured. As shown in FIG. 1, the ejection unit 20 is accommodated in a case CS together with the irradiation unit 30 and the contact unit 40 such that the ejection unit 20 travels in the apparatus width direction by the moving unit 50 to be described below for each case CS (together with the irradiation unit 30 and the contact unit 40). That is, the ejection unit 20 is configured to integrally travel with the irradiation unit 30 and the contact unit 40.

FIG. 1 is a diagram schematically showing a state in which the shaping apparatus 10 according to the present exemplary embodiment shapes the three-dimensional object VM, in which the thickness of each of the layers LR of the three-dimensional object VM and the liquid droplet D are more enlarged than the real thickness of the layers LR and the real liquid droplet D, for easier understanding. The liquid droplet D according to the present exemplary embodiment is, for example, substantially 50 μm in size (diameter) and the thickness of the layer LR is, for example, substantially 30 μm. In addition, in the present exemplary embodiment, the liquid droplet D has an average diameter (average landing diameter) d of, for example, substantially 75 μm after the liquid droplet lands on the layer LR and enters into an equilibrium state.

### Irradiation Unit

The irradiation unit 30 travels together with the ejection unit 20 from the one end side to the other end side in the apparatus width direction and has a function of irradiating the liquid droplet D discharged by the ejection unit 20 with the light LB and of curing the liquid droplet D. Here, the irradiation unit 30 represents an example of a curing section. The light LB applied from the irradiation unit 30 according to the present exemplary embodiment is ultraviolet light as an example.

As shown in FIG. 1 and FIG. 2, the irradiation unit 30 is long and is disposed to be adjacent to the ejection unit 20 on one end side in the apparatus width direction in a state in which a longitudinal direction thereof is parallel to the longitudinal direction of the ejection unit 20. The irradiation unit 30 is configured to perform irradiation toward the top surface side of the base plate BD with the light LB across one end side to the other end side in the longitudinal direction thereof. The irradiation unit 30 may perform the irradiation further from the front side to the back side in the apparatus depth direction than positions of the nozzles N on both ends of the ejection unit 20 in the apparatus depth direction with the light LB.

### Contact Unit

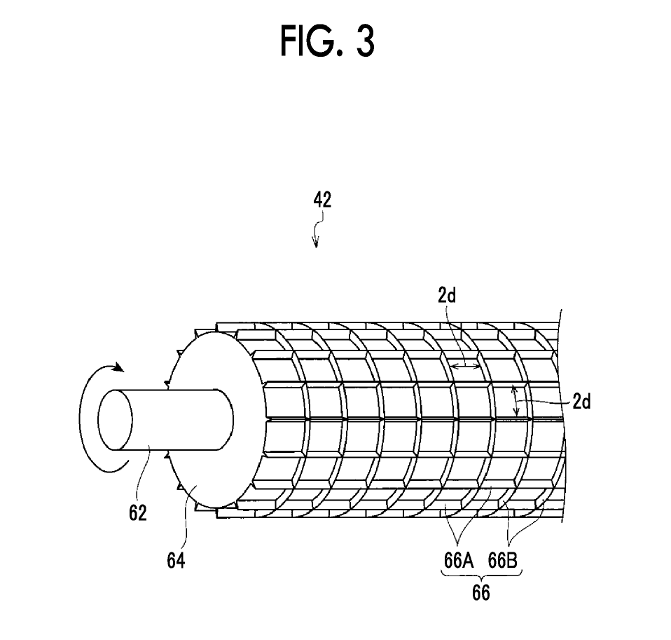

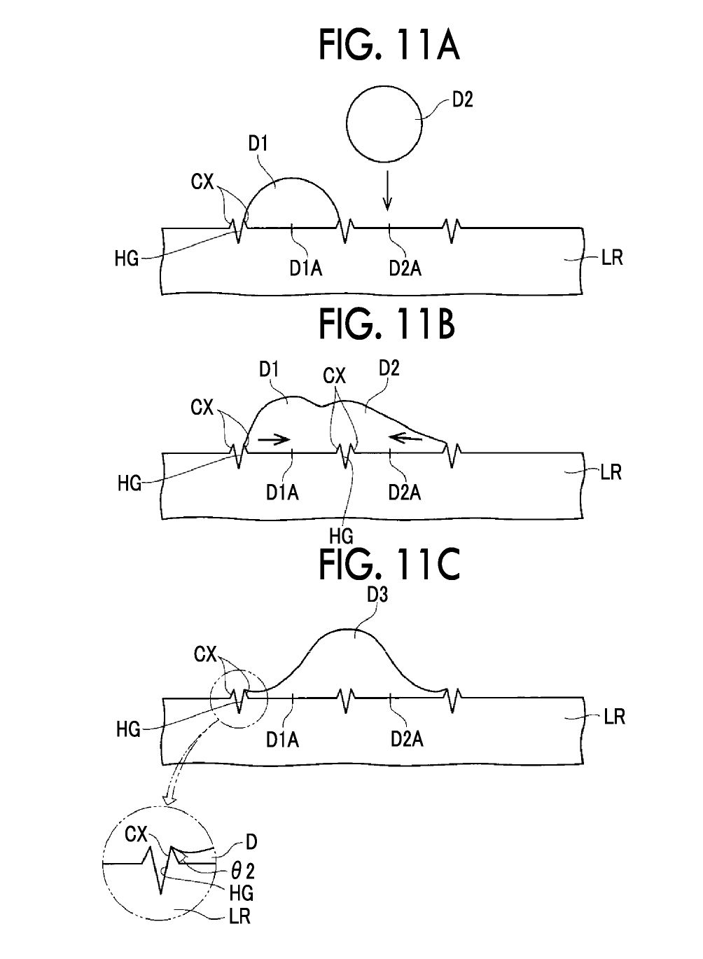

The contact unit 40 has a function of forming a convex portion CX (refer to FIGS. 11A to 11C) that suppresses a movement of the liquid droplet D which is ejected by the ejection unit 20 and lands on a base layer when another layer LR is formed on the layer LR (here, referred to as the base layer) formed of the liquid droplets D. That is, the contact unit 40 has a function of forming, on the base layer, the convex portion CX which suppresses the movement of the liquid droplet D discharged by the ejection unit 20 on the layer LR (base layer). The contact unit 40 travels together with the ejection unit 20 from the one end side to the other end side in the apparatus width direction and is configured to press down on and deform the base layer using a lattice-shaped protrusion 66 (refer to FIG. 3) formed on an outer circumference of a contact roll 60 to be described below and to form the convex portions CX. Here, the convex portion CX represents an example of a suppressing portion. In addition, the contact roll 60 represents an example of a forming section.

As shown in FIG. 1 and FIG. 2, the contact unit 40 is configured to include the contact roll 60 and a driving source (not shown).

The contact roll 60 is long and is disposed to be adjacent to the irradiation unit 30 on the one end side in the apparatus width direction in a state in which the axial direction thereof is parallel to the longitudinal direction of the irradiation unit 30. As shown in FIG. 3, the contact roll 60 includes a rotating shaft 62 and a cylindrical section 64. The cylindrical section 64 is fixed to the outer circumference of the rotating shaft 62 in a state in which both ends of the rotating shaft 62 stick out from both ends of the cylindrical section 64. The one end portion of the rotating shaft 62 is connected to the driving source such that the rotating shaft 62 rotates around the axis thereof.

As shown in FIG. 3, the lattice-shaped protrusion 66 is formed all over the outer circumference of the cylindrical section 64. The lattice-shaped protrusion 66 includes plural protrusions 66A in the axial direction of the cylindrical section 64 and plural protrusions 66B in a circumferential direction of the cylindrical section 64. The plural protrusions 66A and the plural protrusions 66B are disposed in the circumferential direction of the cylindrical section 64 and in the axial direction of the cylindrical section 64, respectively, at equal intervals (a distance of 2d, that is, at an interval that is two times as large as the average landing diameter d of the liquid droplet D). In addition, both ends of the cylindrical section 64 extend to the front side and to the back side in the apparatus depth direction, respectively, further than the nozzles N on both ends of the ejection unit 20 in the apparatus depth direction.

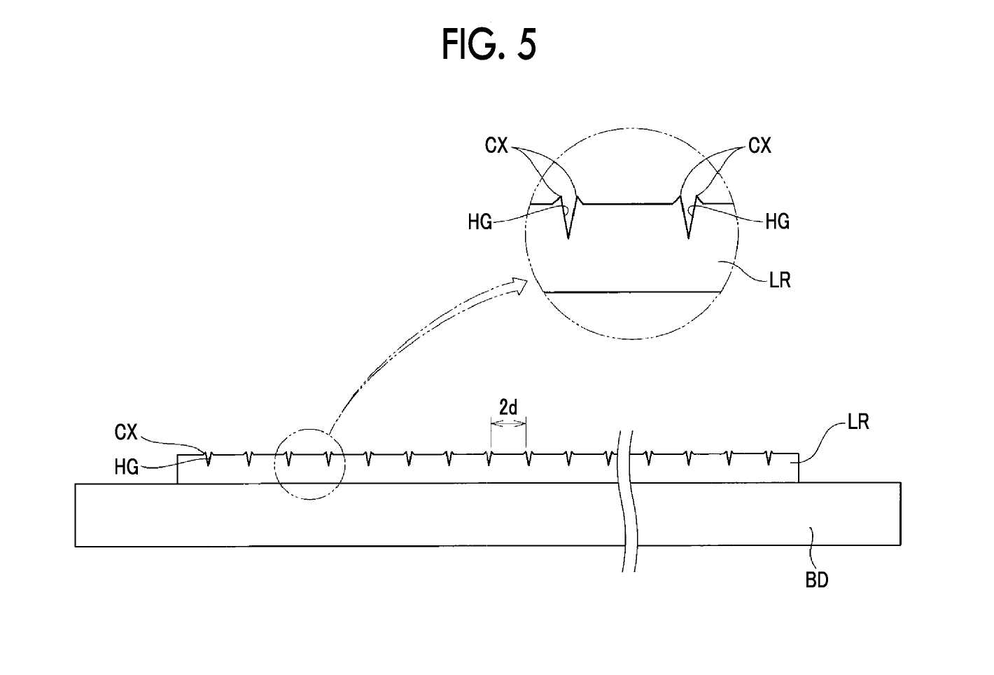

Here, the contact unit 40 is further described. As described above, the contact roll 60 is configured to form the convex portions CX on the layer LR in accordance with the movement of the ejection unit 20 from the one end side to the other end side in the apparatus width direction. In this case, the contact roll 60 has a circumferential speed equal to a traveling speed of the ejection unit 20 in opposite directions to each other. That is, the circumferential speed of the contact roll 60 and the traveling speed of the contact roll 60 in the apparatus width direction have a relationship in which a relative speed becomes 0 therebetween. In addition, the contact roll 60 rotates around the axis and causes the lattice-shaped protrusion 66 to form a concavity into the layer LR so as to travel in the apparatus width direction. According to the above configuration, when the contact roll 60 travels from the one end side to the other end side in the apparatus width direction, a lattice-shaped concavity HG (refer to FIG. 5) corresponding to the lattice-shaped protrusion 66 is formed on the layer LR. The convex portions CX are formed to be adjacent to peripheral edges of the lattice-shaped concavity HG in accordance with the lattice-shaped concavity HG formed on the layer LR.

### Moving Unit

The moving unit 50 has a function of causing the case CS to travel in the apparatus width direction and a function of causing the case CS to travel in the apparatus height direction. As shown in FIG. 1 and FIG. 2, the moving unit 50 is configured to include plural guide rails 52 and a driving source (not shown). The moving unit 50 is configured to be capable of moving the case CS in the apparatus width direction and in the apparatus height direction.

### Control Unit

The control unit 70 has a function of controlling each unit except for the control unit 70 constituting the shaping apparatus 10. The control unit 70 is configured to control the units except for the control unit 70 in response to data received from an external device (not shown). The specific function of the control unit 70 is provided in the following description of an operation of the shaping apparatus 10 to be described below.

### Supplement

The case CS is disposed at a home position by the moving unit 50 which is controlled by the control unit 70 in a period in which the shaping apparatus 10 does not perform a shaping operation, that is, in a period from the end of the shaping operation to the start of the shaping operation. Here, the home position represents a position of an end on the one end side in the apparatus width direction and an end on the lower side in the apparatus height direction. In a state in which the case CS is disposed at the home position, the ejection unit 20, the irradiation unit 30, and the contact unit 40 which are accommodated in the case CS are separated from the top surface of the base plate BD.

As above, the configuration of the shaping apparatus 10 according to the present exemplary embodiment is described.

### Method of Shaping Three-Dimensional Object by Shaping Apparatus According to First Exemplary Embodiment

Next, a method of shaping the three-dimensional object VM by the shaping apparatus 10 according to the present exemplary embodiment (hereinafter, referred to as a shaping method according to the present exemplary embodiment) is described with reference to the drawings.

### Data Conversion

First, when the control unit 70 receives data from an external device, the control unit 70 converts data (that is, three-dimensional data) of the three-dimensional object VM contained in the data into data (that is, two-dimensional data) of a plural layers LR.

### Forming of First Layer

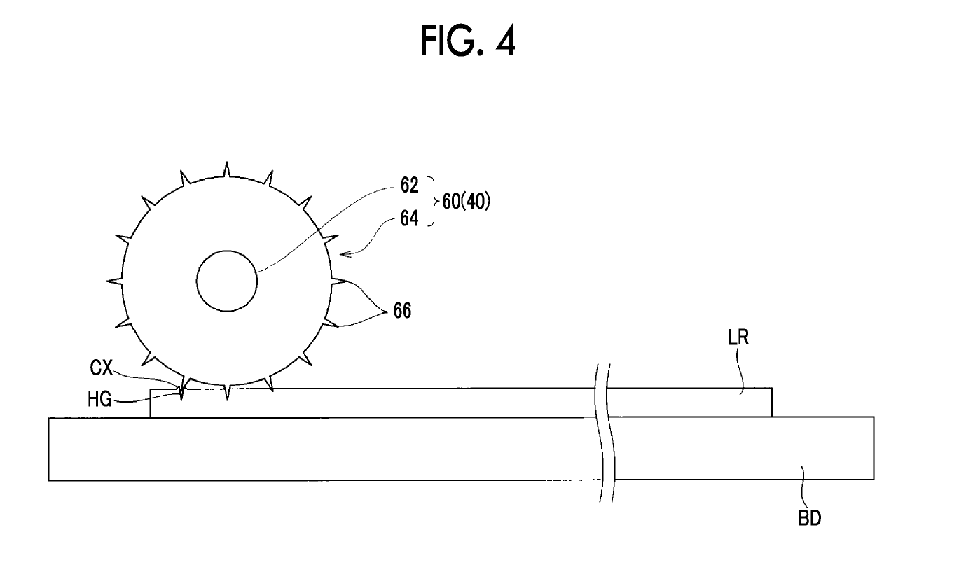

Subsequently, the control unit 70 controls the moving unit 50 such that the case CS disposed at the home position travels from the one end side to the other end side in the apparatus width direction and causes the ejection unit 20 to eject the liquid droplet D. The control unit 70 causes the irradiation unit 30 that moves together with the ejection unit 20 to perform irradiation with the light LB. In addition, the control unit 70 causes the driving source of the contact unit 40 to drive and causes the contact roll 60 that moves together with the ejection unit 20 to rotate around the axis. Through the above operations performed by the control unit 70, the liquid droplets D ejected from the ejection unit 20 are cured immediately after landing on the base plate BD by the light LB and are pressed and deformed by the lattice-shaped protrusion 66 of the contact roll 60 (refer to FIG. 4 and FIG. 5). When the control unit 70 causes the case CS to travel to the end on the other end side in the apparatus width direction, a first layer LR on which the plural convex portions CX are formed is formed.

Subsequently, the control unit 70 controls the moving unit 50 such that the case CS travels to a position on the upper side in the apparatus height direction and further controls the moving unit 50 such that the case CS travels to the end on the one end side in the apparatus width direction. The position on the upper side in the apparatus height direction to which the moving unit 50 causes the case CS to travel becomes a position at which the ejection unit 20, the irradiation unit 30, and the contact unit 40 which are accommodated in the case CS are separated from the first layer LR.

### Forming of Second to Final Layers

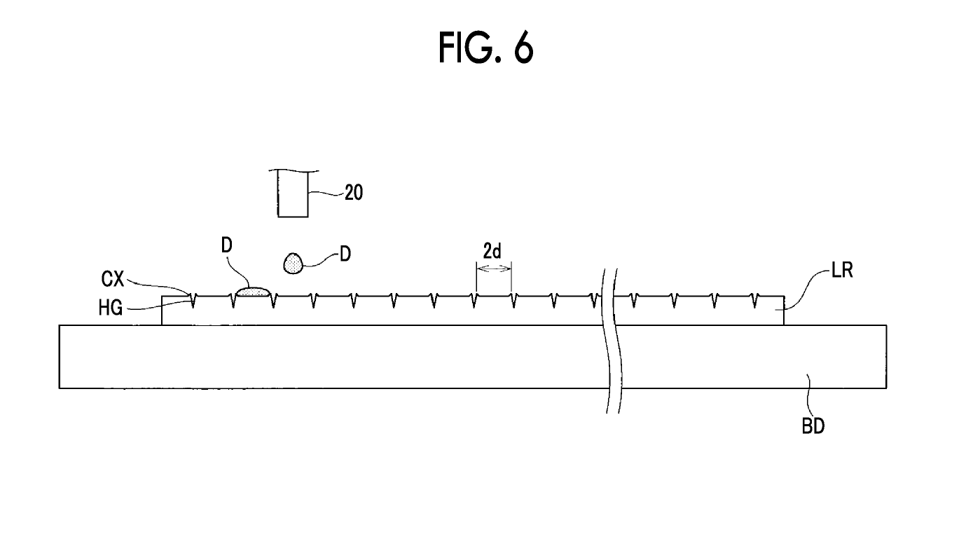

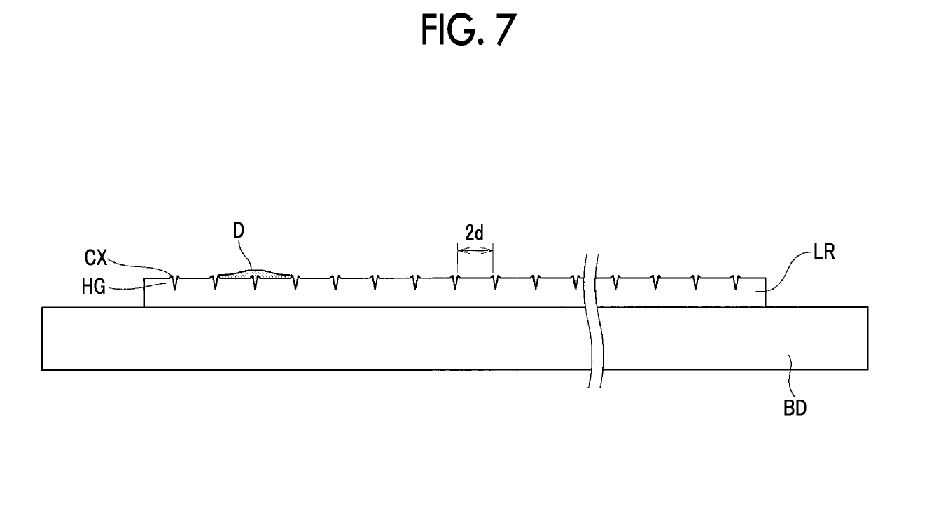

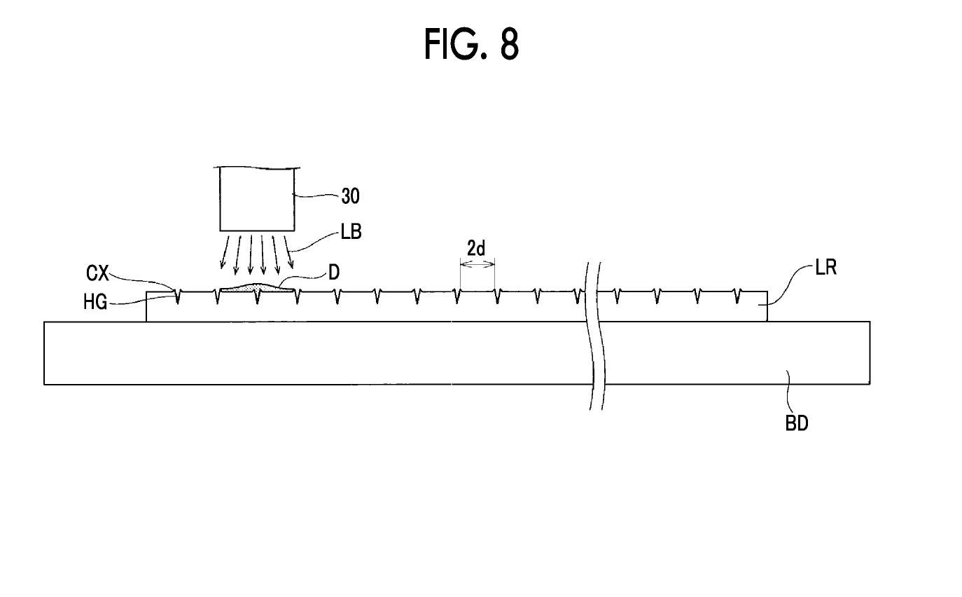

The second to final layers LR are formed by repeating the process of forming the first layer LR described above. In a process of forming the second to final layers LR, the liquid droplets D ejected from the ejection unit 20 land on the layer LR on which the plural convex portions CX are formed (refer to FIG. 6), the adjacent liquid droplets D are integrated with each other (refer to FIG. 7), and the irradiation unit 30 irradiates and cures the liquid droplets D with the light LB (refer to FIG. 8). After the control unit 70 converts the data of the three-dimensional object VM, into which the data is converted, and all of the layers LR are formed in response to the converted data, the control unit 70 causes the case CS to travel to the home position and the shaping method according to the present exemplary embodiment is finished. In a case where the final layer LR (uppermost layer LR) is formed by the shaping apparatus 10, the moving unit 50 causes the case CS to travel from the one end side to the other end side in the apparatus width direction through positions at which the lattice-shaped protrusion 66 of the contact roll 60 does not come into contact with the liquid droplets D ejected by the ejection unit 20 and cured by the irradiation unit 30. Therefore, no convex portions CX are formed on the final layer LR.

As above, the shaping method according to the present exemplary embodiment is described.

### Effects of First Exemplary Embodiment

Next, effects (first to sixth effects) of the present exemplary embodiment will be described with reference to the drawings.

### First Effect

The first effect is described based on a comparison between the shaping apparatus 10 according to the present exemplary embodiment and a shaping apparatus (not shown) according to a first comparative embodiment to be described below. In the following description, in a case where the same components are used in the first comparative embodiment as the components used in the present exemplary embodiment, a description is provided by attaching the same reference signs or the like to the components or the like.

Unlike the shaping apparatus 10 according to the present exemplary embodiment, the shaping apparatus according to the first comparative embodiment does not include the contact unit 40. Therefore, the shaping apparatus according to the first comparative embodiment overlaps the layers LR without forming a convex portion CX on the formed layer LR and shapes the three-dimensional object VM. The shaping apparatus according to the first comparative embodiment has the same configuration as the shaping apparatus 10 according to the present exemplary embodiment except for the above difference.

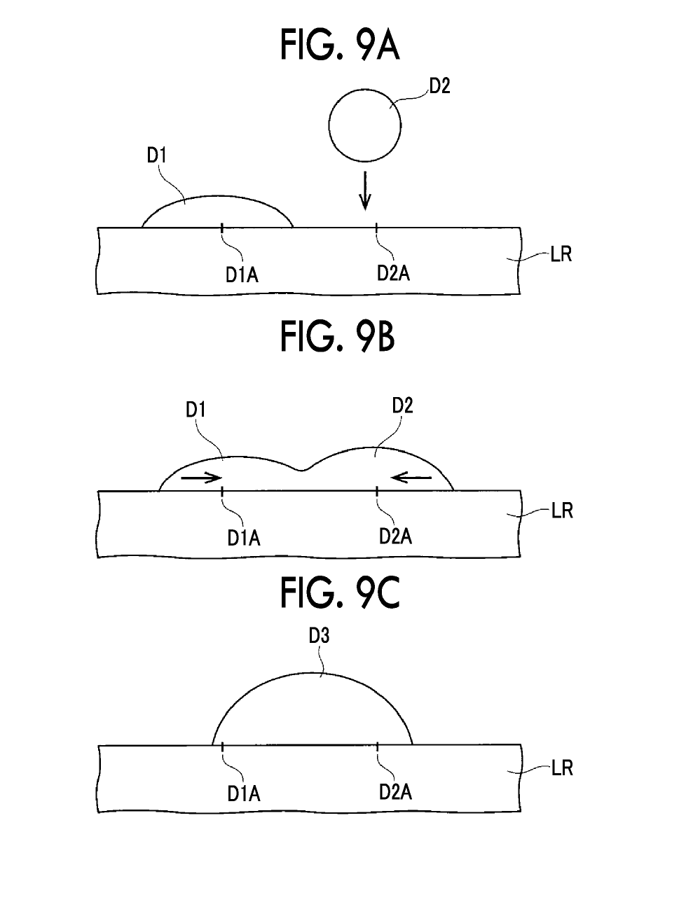

The following description is provided with reference to FIGS. 9A to 9C according to phenomena which occur when the liquid droplets D are caused to land on the layer LR using the shaping apparatus according to the first comparative embodiment.

FIGS. 9A to 9C are diagrams schematically showing the behavior of two liquid droplets D in a case where the two adjacent liquid droplets D (referred to as a liquid droplet D1 and a liquid droplet D2) land on the layer LR. First, the previously landed liquid droplet D1 spreads on the layer LR (FIG. 9A). Subsequently, the liquid droplet D2 which lands at a position adjacent to the liquid droplet D1 on the layer LR spreads on the layer LR and comes into contact with the liquid droplet D1. Then, the liquid droplet D1 and the liquid droplet D2 are attracted to each other by surface tension (FIG. 9B). Subsequently, the liquid droplet D1 and the liquid droplet D2 move to positions shifted from the positions at which the liquid droplets D1 and D2 land, respectively, and form an integrated liquid droplet D3 (FIG. 9C). The liquid droplet D3 on the layer LR is cured by the light LB with which the irradiation unit 30 performs the irradiation. A position D1A in the drawings represents a center of a landing position of the liquid droplet D1 and a position D2A represents a center of a landing position of the liquid droplet D2.

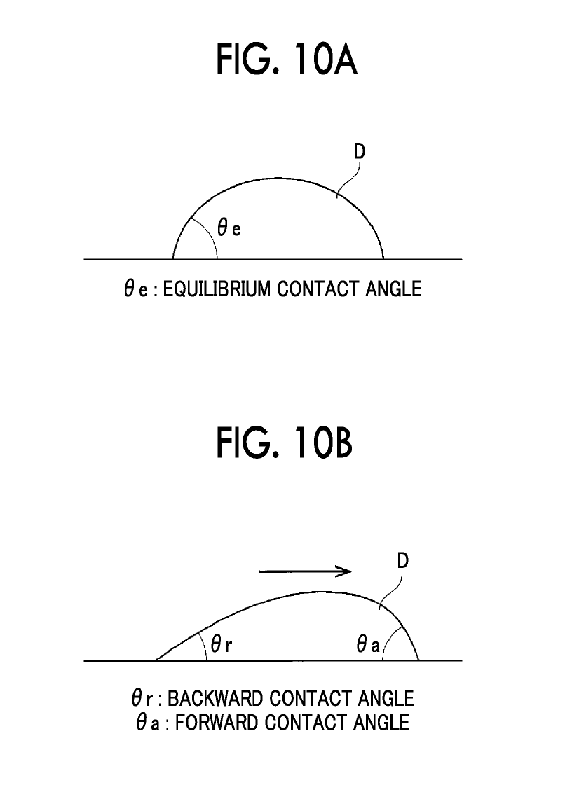

As above, when the adjacent liquid droplets D1 and D2 land on the layer LR using the shaping apparatus according to the first comparative embodiment, there is concern that the liquid droplets D1 and D2 will move to and will be cured at the positions shifted from the landing positions D1A and D2A, respectively. As shown in FIG. 10B, the liquid droplet D moving on the layer LR is formed to have a relationship of a contact angle (referred to as a forward contact angle θa) on a side in a moving direction of the liquid droplet D, which is equal to or greater than an equilibrium contact angle θe (refer to FIG. 10A), and a contact angle (referred to as a backward contact angle θr) on a side opposite to the side in the moving direction of the liquid droplet D, which is equal to or less than the equilibrium contact angle θe.

Unlike the shaping apparatus according to the first comparative embodiment, the shaping apparatus 10 according to the present exemplary embodiment includes the contact unit 40 which forms the plural convex portions CX on the formed layer LR. Therefore, when the adjacent liquid droplets D land on the layer LR using the shaping apparatus 10 according to the present exemplary embodiment, these liquid droplets D are pinned by the convex portions CX formed on the layer LR and are unlikely to spread like a liquid droplet D1 in FIG. 11A. In addition, after a liquid droplet D2 landing at a position adjacent to the liquid droplet D1 on the layer LR lends, the liquid droplet D2 comes into contact with the adjacent liquid droplet D1 and moves to integrate with the liquid droplet D1; however, the liquid droplet D2 is pinned by the convex portion CX on the side opposite to the side which comes into contact with the liquid droplet D1 and thus, it is difficult to move to the liquid droplet D1 side (refer to FIG. 11B). The liquid droplet D1 and the liquid droplet D2 are integrated with each other and form the liquid droplet D3; however, the liquid droplet D3 is pinned by the convex portions CX on both sides. Therefore, in the case of the present exemplary embodiment compared to the case of the first comparative embodiment, the liquid droplets D1 and D2 are unlikely to move to the positions shifted from the landing positions D1A and D2A, respectively.

A state in which the liquid droplets D1, D2, and D3 are pinned by the convex portions CX means a state in which it is not possible for the liquid droplets D1, D2, and D3 to be separated from the convex portions CX. In the case of the present exemplary embodiment, as shown in FIG. 11C, when the liquid droplet D3 is pinned by the convex portions CX, the liquid droplet D3 forms a contact angle θ2 with the convex portions CX. Therefore, the contact angle θ2 is unlikely to become equal to or greater than the backward contact angle θr.

Accordingly, the shaping apparatus 10 according to the present exemplary embodiment may shape a three-dimensional object with high accuracy compared to a shaping apparatus which ejects the liquid droplet Don the layer LR, overlaps the layers LR, and shapes a three-dimensional object, without forming the suppressing portion which suppresses a movement of the liquid droplet D on the layer LR formed of the liquid droplets D.

### Second Effect

Next, the second effect is described based on a comparison between the shaping apparatus 10 according to the present exemplary embodiment and a shaping apparatus (not shown) according to a second comparative embodiment to be described below. In the following description, in a case where the same components are used in the second comparative embodiment as the components used in the present exemplary embodiment, a description is provided by attaching the same reference signs or the like to the components or the like.

Unlike the shaping apparatus 10 according to the present exemplary embodiment, in the shaping apparatus according to the second comparative embodiment, a contact roll forms plural convex portions CX such that the plural convex portions CX are formed on the layer LR at an interval that is more than two times as large as the average landing diameter d of the liquid droplet D. The shaping apparatus according to the second comparative embodiment has the same configuration as the shaping apparatus 10 according to the present exemplary embodiment except for the above difference. The shaping apparatus according to the second comparative embodiment is included in a technical scope of the invention.

The shaping apparatus according to the second comparative embodiment has the first effect described above. However, when a three-dimensional object VM is formed using the shaping apparatus according to the second comparative embodiment, the liquid droplet D landing on the layer LR does not come into contact with the convex portions CX in some cases. The liquid droplet D is not pinned by the convex portion CX.

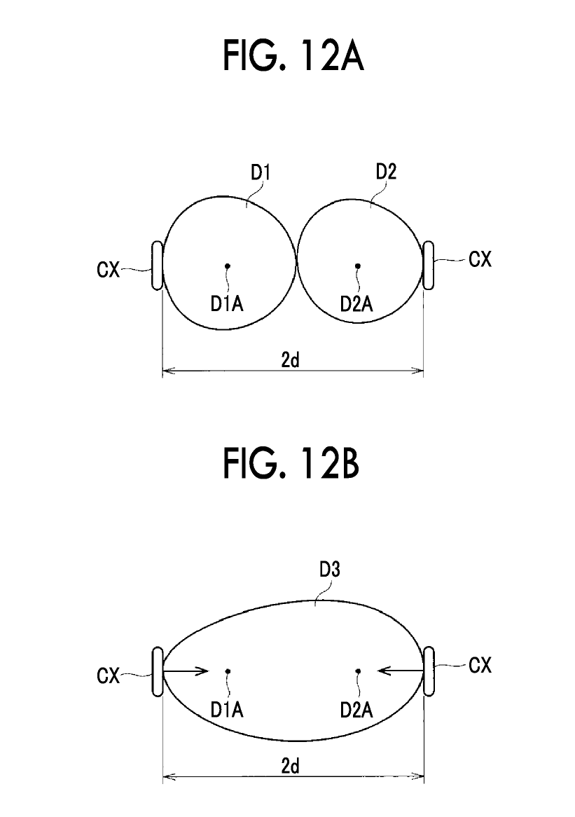

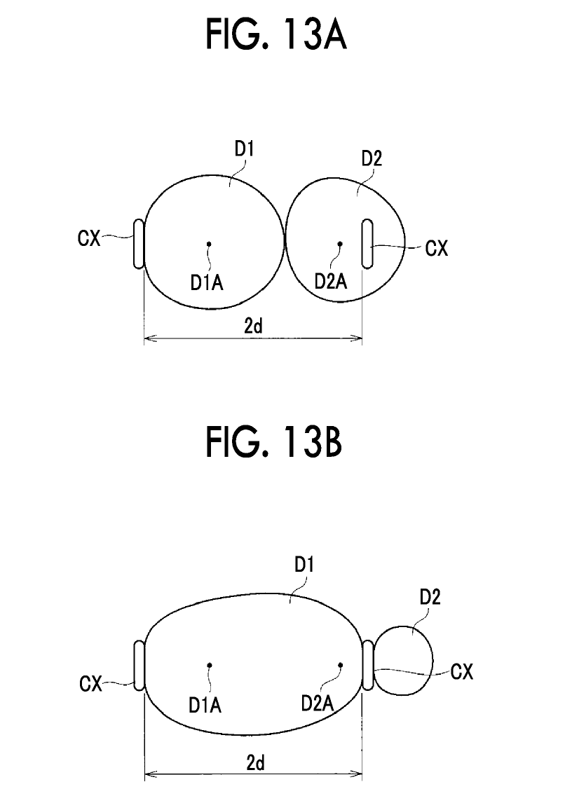

In contrast, in the case of the present exemplary embodiment, the plural convex portions CX are disposed at an interval that is two times as large as the average landing diameter d of the liquid droplet D. Therefore, in the case of the present exemplary embodiment, as shown in FIGS. 12A and 13B, when the adjacent liquid droplets D1 and D2 land on the layer LR, the liquid droplets D1 and D2 are in contact with any one of the plural convex portions CX which are formed on the layer LR. As a result, the liquid droplets D1 and D2 are pinned by the convex portions CX either in the case of integrating as in FIG. 12B or in a case of being separated as in FIG. 13B.

According to the shaping apparatus 10 according to the present exemplary embodiment compared to the shaping apparatus in which the contact unit forms the plural convex portions CX such that convex portions CX are formed to be adjacent at an interval that is more than two time as large as the landing diameter of the liquid droplet D, it is possible to form the three-dimensional object VM with high accuracy. In the case of the present exemplary embodiment, as above, the plural convex portions CX are disposed on the layer LR at an interval that is two times as large as the average landing diameter d of the liquid droplet D; however, it is needless to say that the effect is also achieved in a case in which the plural convex portions CX are disposed at an interval that is less than two times as large as the average landing diameter d of the liquid droplet D.

### Third Effect

Next, the third effect will be described. As shown in FIG. 3 and FIG. 4, in the shaping apparatus 10 according to the present exemplary embodiment, the layer LR is pressed and deformed by the contact roll 60 such that the convex portions CX are formed on the layer LR. Therefore, the shaping apparatus 10 according to the present exemplary embodiment causes the layer LR to be deformed and may form the plural convex portions CX on the layer LR.

### Fourth Effect

Next, the fourth effect is described based on a comparison between the shaping apparatus 10 according to the present exemplary embodiment and a shaping apparatus (not shown) according to a third comparative embodiment to be described below. In the following description, in a case where the same components are used in the third comparative embodiment as the components used in the present exemplary embodiment, a description is provided by attaching the same reference signs or the like to the components or the like.

Unlike the shaping apparatus 10 according to the present exemplary embodiment, in the shaping apparatus according to the third comparative embodiment, the irradiation unit 30 and the contact roll 60 are disposed in a state of switching the positions thereof. That is, the ejection unit 20, the contact roll 60, and the irradiation unit 30 are arranged and accommodated in this order in the case CS. The shaping apparatus according to the third comparative embodiment has the same configuration as the shaping apparatus 10 according to the present exemplary embodiment except for the above difference. The shaping apparatus according to the third comparative embodiment is included in a technical scope of the invention.

In a case where a three-dimensional object VM is formed using the shaping apparatus according to the third comparative embodiment, the lattice-shaped protrusion 66 of the contact roll 60 presses down on and deforms the liquid droplet D before the liquid droplet D is irradiated and cured with the light LB from the irradiation unit 30, and then the irradiation unit 30 irradiates the liquid droplet D with the light LB. Therefore, it is not possible for the liquid droplet D to maintain the deformed shape until the liquid droplet D is irradiated and cured with the light LB from the irradiation unit 30 after being deformed by the contact roll 60. The shaping apparatus according to the third comparative embodiment achieves the first and second effects described above.

Accordingly, according to the shaping apparatus 10 according to the present exemplary embodiment compared to the shaping apparatus in which the layer LR is cured after the plural convex portions CX are formed on the layer LR, it is possible to form the plural convex portions CX having stable shapes.

### Fifth Effect

Next, the fifth effect is described based on a comparison between the shaping apparatus 10 according to the present exemplary embodiment and a shaping apparatus (not shown) according to a fourth comparative embodiment to be described below. In the following description, in a case where the same components are used in the fourth comparative embodiment as the components used in the present exemplary embodiment, a description is provided by attaching the same reference signs or the like to the components or the like.

Unlike the shaping apparatus 10 according to the present exemplary embodiment, in the shaping apparatus according to the fourth comparative embodiment, the contact unit is a member which is provided with plural blades in the apparatus width direction on a long plate. The shaping apparatus according to the fourth comparative embodiment has the same configuration as the shaping apparatus 10 according to the present exemplary embodiment except for the above difference. The shaping apparatus according to the fourth comparative embodiment is included in a technical scope of the invention.

When a three-dimensional object VM is formed using the shaping apparatus according to the fourth comparative embodiment, it is possible to form the plural convex portions on the layer LR in the traveling direction (direction facing the plural blades) of the case CS. However, the contact unit according to the fourth comparative embodiment travels from the one end side to the other end side in the apparatus width direction, and scratches the layer LR in a direction (for example, apparatus depth direction) different from the traveling direction of the case CS. Thus, it is not possible to form a convex portion. The shaping apparatus according to the fourth comparative embodiment has the first to fourth effects described above.

In contrast, the lattice-shaped protrusion 66 is formed on the outer circumference of the cylindrical section 64 of the contact roll 60 according to the present exemplary embodiment. The lattice-shaped protrusion 66 comes into contact with and presses down on the layer LR in accordance with the rotation of the contact roll 60 around the axis and the lattice-shaped convex portions CX facing plural directions (in the case of the present exemplary embodiment, for example, two directions of the apparatus width direction and the apparatus depth direction) are formed on the layer LR.

Accordingly, according to the shaping apparatus 10 according to the present exemplary embodiment, it is possible to form the plural convex portions CX facing the plural directions, all at once on the layer LR.

### Sixth Effect

Next, the sixth effect is described based on a comparison between the shaping apparatus 10 according to the present exemplary embodiment and a shaping apparatus (not shown) according to a fifth comparative embodiment to be described below. In the following description, in a case where the same components are used in the fifth comparative embodiment as the components used in the present exemplary embodiment, a description is provided by attaching the same reference signs or the like to the components or the like.

Unlike the shaping apparatus 10 according to the present exemplary embodiment, in the shaping apparatus according to the fifth comparative embodiment, the contact unit is not accommodated in the case CS. The contact unit according to the fifth comparative embodiment is formed of a plate having one surface on which a lattice-shaped protrusion is formed. In the shaping apparatus according to the fifth comparative embodiment, the ejection unit 20 ejects the liquid droplet D and the layer LR is formed. After the irradiation unit 30 irradiates and cures the layer LR with the light LB, the contact unit presses down on the layer LR from the upper side such that the plural convex portions CX are formed on the layer LR. The shaping apparatus according to the fifth comparative embodiment has the same configuration as the shaping apparatus 10 according to the present exemplary embodiment except for the above difference. The shaping apparatus according to the fifth comparative embodiment is included in a technical scope of the invention.

When a three-dimensional object VM is formed using the shaping apparatus according to the fifth comparative embodiment, it is possible to form the plural convex portions CX on the layer LR. However, in the shaping apparatus according to the fifth comparative embodiment, it is not possible to form the plural convex portions CX on the layer LR in accordance with an ejection operation of the liquid droplet D by the ejection unit 20 and a curing operation of the layer LR by the irradiation unit 30. In the case of the fifth comparative embodiment, in order to form the plural convex portions CX, the forming process needs to be performed at a timing after the ejection operation of the liquid droplet D by the ejection unit 20 and the curing operation of the layer LR by the irradiation unit 30.

In contrast, in the case of the present exemplary embodiment, as above, the ejection unit 20, the irradiation unit 30, and the contact unit 40 are accommodated in the case CS and the operations are performed in equilibrium in accordance with the traveling of the case CS. Accordingly, in the shaping apparatus 10 according to the present exemplary embodiment compared to the shaping apparatus in which the contact unit is not formed to be able to travel together with the ejection unit 20 and the irradiation unit 30 and is formed of a plate having one surface on which the protrusions are formed, it is possible to form the three-dimensional object VM in a short amount of time.

### Modification Example of First Exemplary Embodiment

Next, a shaping apparatus 10A according to a modification example of the first exemplary embodiment will be described with reference to the drawings. First, a configuration of the shaping apparatus 10A of the modification example is described. Subsequently, an operation by the shaping apparatus 10A of the modification example will be described. Then, effects of the modification example will be described. In the following description, in a case where the same components are used in the modification example as the components used in the present exemplary embodiment, a description is provided by attaching the same reference signs or the like to the components or the like.

### Configuration of Shaping Apparatus of Modification Example

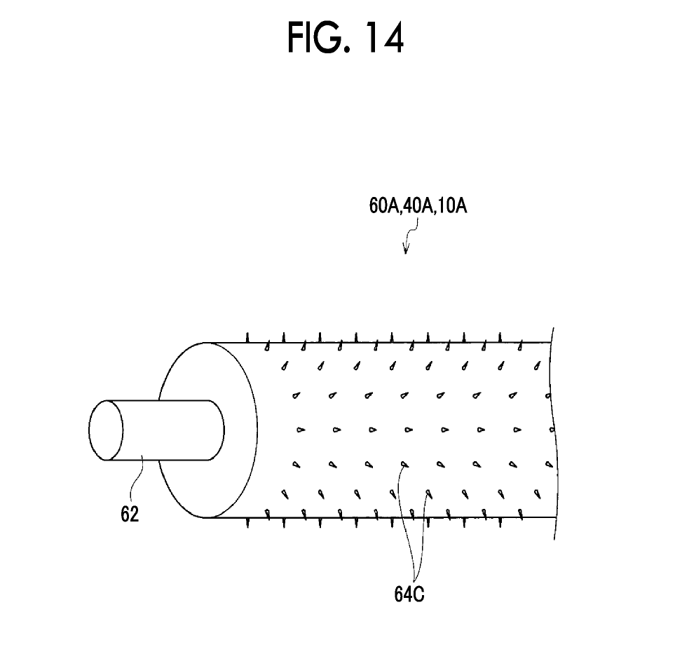

As shown in FIG. 14, in the shaping apparatus 10A of the modification example, plural needle-shaped protrusions 66C are formed on the outer circumference of a contact roll 60A constituting a contact unit 40A instead of the lattice-shaped protrusion 66 formed on the contact roll 60 in the shaping apparatus 10 according to the first exemplary embodiment. The plural needle-shaped protrusions 66C are disposed in the circumferential direction and in the axial direction of a cylindrical section 64A at equal intervals (a distance of 2d, that is, at an interval that is two times as large as the average landing diameter d of the liquid droplet D). The shaping apparatus 10A of the modification example has the same configuration as the shaping apparatus 10 according to the first exemplary embodiment except for the above difference.

### Method of Shaping Three-Dimensional Object by Shaping Apparatus of Modification Example

A shaping method of the modification example is performed in the same order (order of finishing through forming the layers LR after the data conversion), as in the shaping method according to the first exemplary embodiment.

### Effects of Modification Example

Effects of the modification example are the same as the effects of the first exemplary embodiment.

### Second Exemplary Embodiment

Next, a shaping apparatus 10B according to the second exemplary embodiment will be described with reference to the drawings. First, a configuration of the shaping apparatus 10B according to the present exemplary embodiment is described. Substantially, an operation of the shaping apparatus 10B according to the present exemplary embodiment will be described. Then, effects of the present exemplary embodiment will be described. In the following description, in a case where the same components are used in the present exemplary embodiment as the components used in the first exemplary embodiment and the modification examples thereof, a description is provided by attaching the same reference signs or the like to the components or the like.

### Configuration of Shaping Apparatus According to Second Exemplary Embodiment

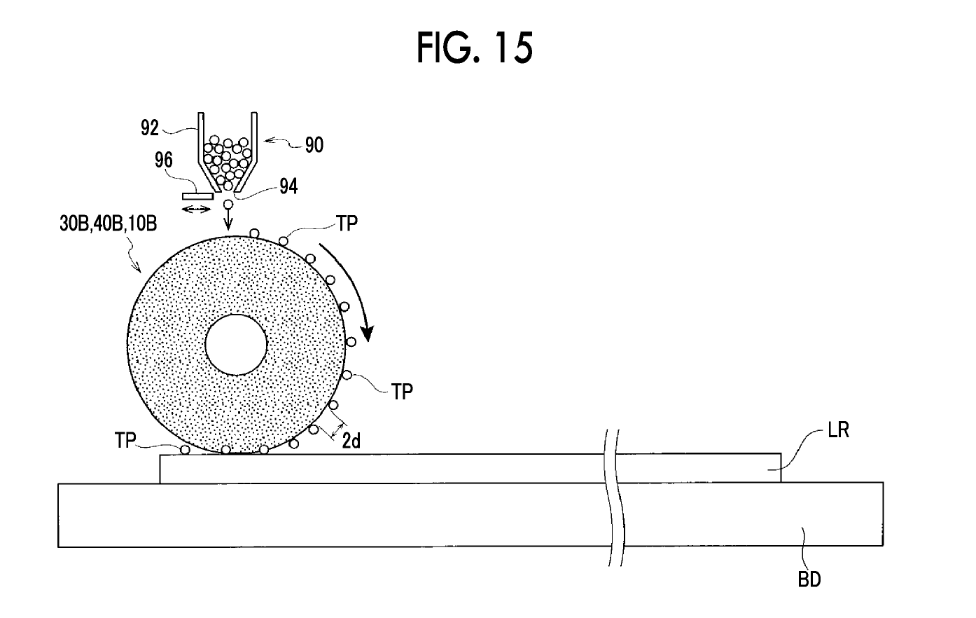

As shown in FIG. 15, the shaping apparatus 10A according to the present exemplary embodiment includes a contact unit 40B instead of the contact unit 40 in the shaping apparatus 10 according to the first exemplary embodiment. The contact unit 40B is configured to include a contact roll 60B, a dropping unit 90 that causes a particle TP to drop from the upper side of the contact roll 60B, and a driving source (not shown). Here, the contact roll 60B represents an example of the forming section. In addition, the particle TP represents an example of a suppressing portion and a convex portion. Here, the dropping unit 90 includes a container 92 in which the particles TP are accommodated, plural holes 94 formed on the lower side of the container 92 and disposed at intervals 2d along the axial direction of the contact roll 60B, and a shutter 96 that blocks the plural holes 94 at a predetermined timing. The particle TP may pass through the plural holes 94. The shaping apparatus 10B according to the present exemplary embodiment has the same configuration of the shaping apparatus 10 according to the first exemplary embodiment except for the above difference.

### Method of Shaping Three-Dimensional Object by Shaping Apparatus According to Second Exemplary Embodiment

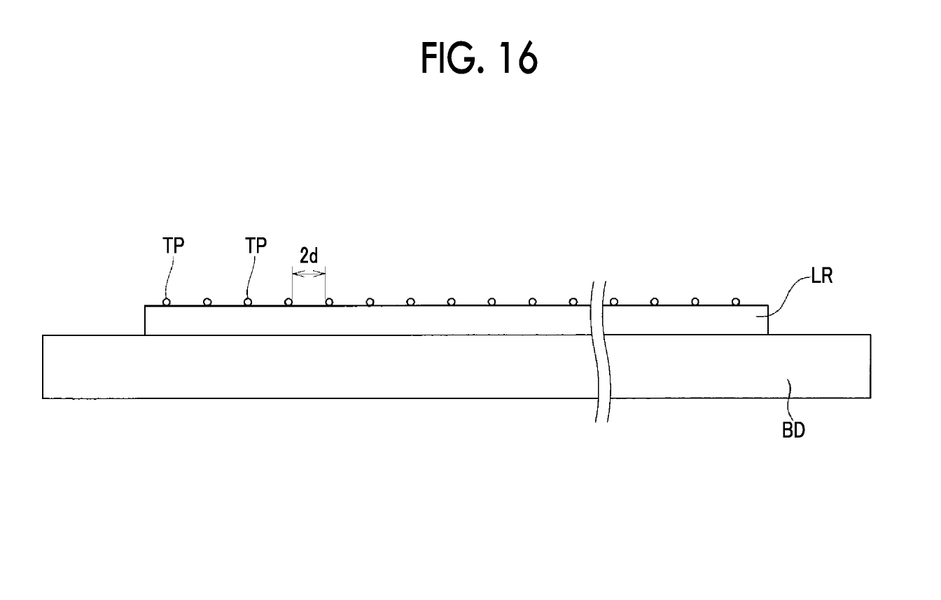

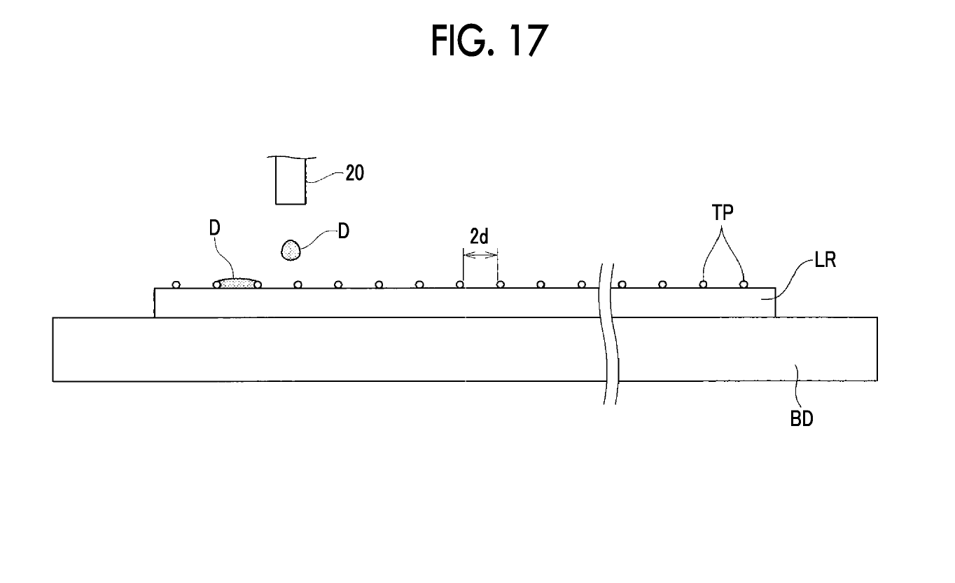

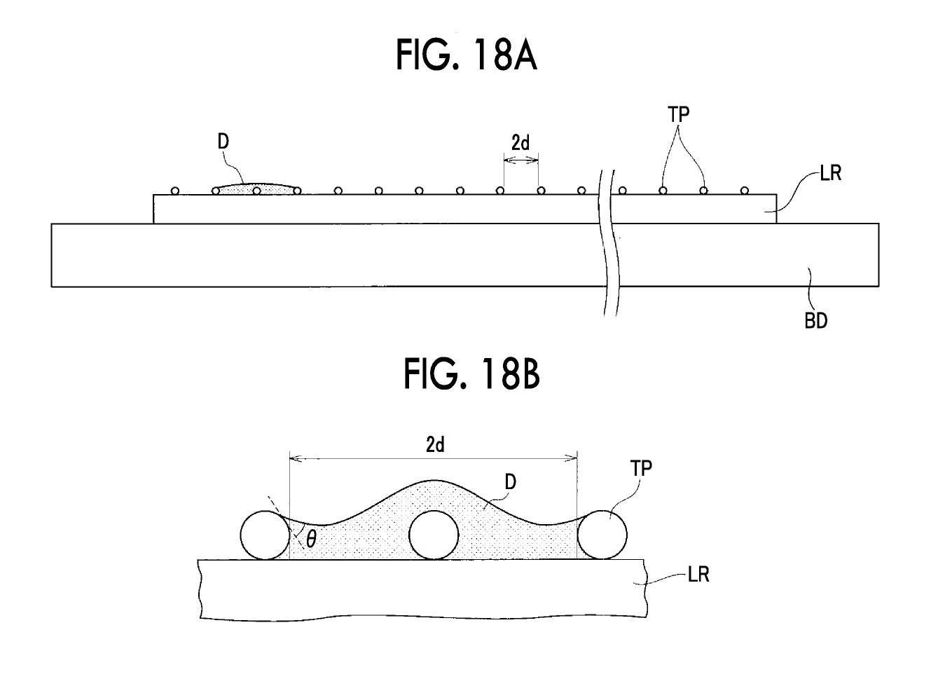

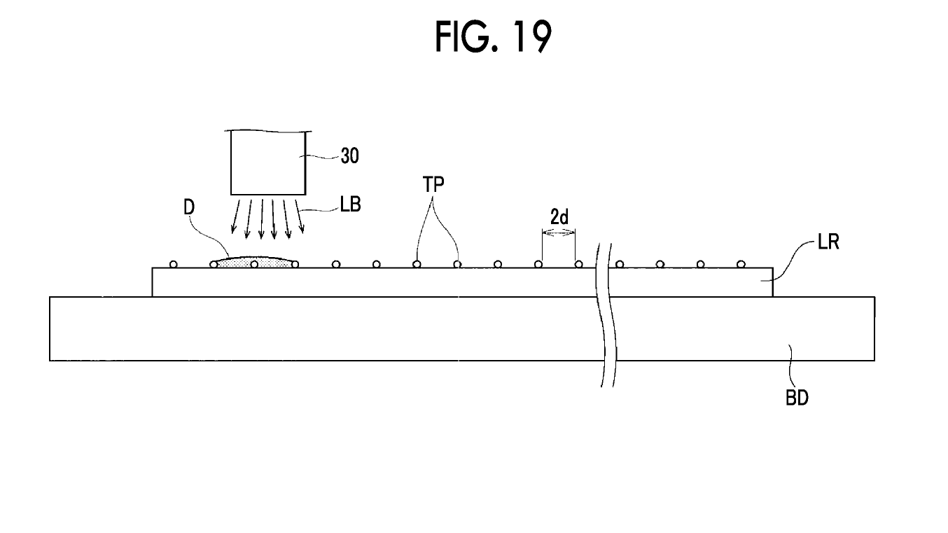

A shaping method according to the present exemplary embodiment is performed in the same order (order of finishing through forming the layers LR after the data conversion) as in the shaping method according to the first exemplary embodiment. Here, a difference between the present exemplary embodiment and the first exemplary embodiment, that is, adhering the particle TP to the layer LR, is described. While the contact unit 40B according to the present exemplary embodiment travels from the one end side to the other end side in the apparatus width direction in accordance with the movement of the case CS, the control unit 70 causes the shutter 96 to move at a predetermined timing (for example, timing at which the contact roll 60B rotates by 2d in the circumferential direction). The dropping unit 90 causes the particle TP to be disposed on the outer circumference of the contact roll 60B at intervals 2d in the circumferential direction (refer to FIG. 15). The particle TP disposed on the outer circumference of the contact roll 60B adheres to the layer LR at a nip between the contact roll 60B and the layer LR and the particles TP are disposed on the layer LR at the intervals 2d (refer to FIG. 16). As a result, the particle TP disposed on the layer LR forms the convex portions on the layer LR. The liquid droplet D ejected from the ejection unit 20 lands on the layer LR to which the particle TP adheres (refer to FIG. 17), the adjacent liquid droplets D are integrated with each other (refer to FIGS. 18A and 18B), and the liquid droplets D are irradiated and cured with the light LB by the irradiation unit 30 (refer to FIG. 19).

### Effects of Second Exemplary Embodiment

As above, a liquid forming the liquid droplet D according to the present exemplary embodiment is transparent. Therefore, in the case of the present exemplary embodiment, it is possible to shape a three-dimensional object VM in a color by the color of the particle TP. The other effects of the present exemplary embodiment are the same as those in the cases of the first exemplary embodiment and the modification examples.

In the case of the present exemplary embodiment, as in the third comparative embodiment described above, the irradiation unit 30 and the contact roll 60 may be disposed in a state of switching the positions thereof, the liquid droplet D may be irradiated with the light LB by the irradiation unit 30 after the particle TP adheres to the liquid droplet D, and the liquid droplet D may be cured such that the layer LR may be formed. In this case, a part of the particles TP are buried due to its own weight in the liquid droplet D before curing such that adhesiveness of the particles TP is improved.

As above, although a specific exemplary embodiment of the invention has been described in detail, the invention is not limited to the exemplary embodiments described above and other various exemplary embodiments may be performed within a scope of the invention.

For example, in the description of the exemplary embodiments, the ejection unit 20, the irradiation unit 30, and the contact unit 40 are accommodated in the case CS and travel integrally with each other in the apparatus width direction. However, the ejection unit 20, the irradiation unit 30, and the contact unit 40 may be configured to travel separately.

In addition, in the description of the exemplary embodiment, a light curable resin represents an example of the curable resin. However, as another aspect included in the technical scope of the invention, the shaping apparatus may use a thermosetting resin instead of the light curable resin. In this case, a layer configured to contain the thermosetting resin may be heated by light or may be heated by hot air.

In addition, in the description of the exemplary embodiments, the light curable resin represents an example of the curable resin. However, as another aspect included in the technical scope of the invention, the shaping apparatus may use a thermoplastic resin instead of the light curable resin. In this case, a heater is provided in a head, and it is possible for a liquid to be ejected as a liquid droplet in a state in which the liquid in the head is heated, and it is possible to form a layer formed of the liquid droplets cooled at room temperature. Therefore, in the shaping apparatus which forms the three-dimensional object VM with the liquid droplet containing the thermoplastic resin, there is no need to provide an irradiation section that irradiates the formed layer with light and a section that applies heat.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A shaping apparatus comprising:
an ejection section that ejects a liquid droplet containing a curable resin and that overlaps layers formed of the liquid droplets to form a three-dimensional object; and
a forming section that forms, on the layer, a suppressing portion that suppresses a movement of the liquid droplet ejected by the ejection section on the layer.

2. The shaping apparatus according to claim 1, wherein
the forming section forms a plurality of convex portions as the suppressing portions at an interval between the adjacent convex portions, that is two times or less as large as a landing diameter of the liquid droplet.

3. The shaping apparatus according to claim 2, wherein
the forming section includes a protrusion, deforms the layer formed of the liquid droplets using the protrusion, and forms the plurality of convex portions on the layer.

4. The shaping apparatus according to claim 3, further comprising:
a curing section that cures the liquid droplet,
wherein the forming section forms the plurality of convex portions on the layer forms of the liquid droplets cured by the curing section.

5. The shaping apparatus according to claim 2, wherein
the liquid droplet is transparent after being cured, and
the forming section causes powder to adhere to the layer formed of the liquid droplets to form the plurality of convex portions on the layer.

6. The shaping apparatus according to claim 1, wherein
the curable resin is a light curable resin or a thermosetting resin.
